(19) United States
(12) Patent Application Publication
(10) Pub. No.: US 2018/0242126 A1
(43) Pub. Date: Aug. 23, 2018

(54) Electronic Shelf-Label System

(71) Applicant: Wal-Mart Stores, Inc., Bentonville, AR (US)

(72) Inventors: Neeta N. Shah, Bentonville, AR (US); Anthony G. Wind, III, Gravette, AR (US)

(21) Appl. No.: 15/876,611

(22) Filed: Jan. 22, 2018

Related U.S. Application Data
(60) Provisional application No. 62/460,299, filed on Feb. 17, 2017.

(51) Int. Cl. H04W 4/35; A47B 96/02; G06K 19/077; G06Q 30/06; G06Q 10/08; H04W 4/38

(52) U.S. Cl. CPC H04W 4/35; A47B 96/02; G06K 19/07707; G06K 2017/0051; G06Q 10/087; H04W 4/38; G06Q 30/06

(57) ABSTRACT

Described in detail herein are systems and methods for an electronic shelf label system. An electronic shelf-label disposed on shelving units and including an LED display can display a first set of information and a second set of information associated with like physical objects disposed on the supporting surfaces of shelves of the shelving units. Sensors disposed on the supporting surfaces of the shelves of the shelving unit, can detect attributes associated with the at least one set of like physical objects disposed on the shelving unit. The sensors can encode the attributes into electrical signals and transmit the electrical signals to a computing system. The computing system, can control an output of the at least one electronic shelf-label to change the display of the first and second set of information based on the plurality of attributes detected by the plurality of sensors.

### CROSS-REFERENCE TO RELATED PATENT APPLICATIONS

This application claims priority to U.S. Provisional Application No. 62/460,299 filed on Feb. 17, 2017, the content of which is hereby incorporated by reference in its entirety.

### BACKGROUND

Electronic shelf labels can typically display predefined information to a user regarding one or more items on the shelf.

### BRIEF DESCRIPTION OF DRAWINGS

Illustrative embodiments are shown by way of example in the accompanying drawings and should not be considered as a limitation of the present disclosure. The accompanying figures, which are incorporated in and constitute a part of this specification, illustrate one or more embodiments of the invention and, together with the description, help to explain the invention. In the figures:

FIG. 1 is a schematic diagram of an exemplary shelving unit with electronic shelf-labels according to an exemplary embodiment;

FIG. 2 illustrates an exemplary electronic shelf-label according to an exemplary embodiment;

FIG. 3 illustrates an array of sensors in accordance with an exemplary embodiment;

FIG. 4 illustrates an exemplary electronic shelf-label system in accordance with an exemplary embodiment;

FIG. 5 illustrates an exemplary computing device in accordance with an exemplary embodiment;

FIG. 6 is a flowchart illustrating a process of the electronic shelf-label system according to an exemplary embodiment; and

FIG. 7 is a flowchart illustrating a process of the electronic shelf-label system according to an exemplary embodiment.

### DETAILED DESCRIPTION

Described in detail herein are systems and methods for an electronic shelf label system. An electronic shelf-label can be disposed on a shelving units and can include a display (e.g., an LED display). The display can render a first set of information and a second set of information associated with like physical objects disposed on the supporting surfaces of shelves of the shelving units and to which the electronic label is assigned. Sensors disposed on the supporting surfaces of the shelves of the shelving unit, can detect attributes associated with the physical objects disposed on the shelving unit and assigned to the electronic shelf-label. The sensors can encode the detected attributes into electrical signals and transmit the electrical signals to a computing system. The computing system, can dynamically control an output of the at least one electronic shelf-label to change the display of the first and second set of information based on changes to the attributes detected by the sensors.

An electronic shelf-label system includes electronic shelf-labels disposed on shelving units. The electronic shelf-labels are configured to display a first set of information and a second set of information associated with like physical objects disposed on the shelving units. The system further includes sensors disposed on the shelving units. The sensors can be configured to detect attributes associated with the like physical objects disposed on the shelving unit and assigned to respective ones of the electronic shelf-labels. The system further includes a computing system operatively coupled to the sensors and the electronic shelf-labels. The computing system is configured to control an output of an electronic shelf-label to change the display of the first and second set of information based on the attributes detected by the plurality of sensors. The first set of information can be a quantity of physical objects disposed on the shelving units and the second set of information can be an amount of time until additional like physical objects are added to the shelving units.

The computing system is further configured to query the database to retrieve the quantity of at least one set of like physical objects disposed on the shelving units, based on the set of attributes and estimate the amount of time until additional like physical objects are added to the shelving units based on the quantity of at least one set of like physical objects. The computing system is configured to transmit an alert in response to determining the amount of time is less than a specified threshold amount of time.

The shelving units can be disposed in a first location in a facility, and the computing system can be configured to determine the like physical objects are absent from the shelving units disposed in the first location in the facility based on the output of one or more sensors, determine additional like physical objects are present in a second location in the facility based on the output of one or more sensors, and transmit an alert to retrieve the additional like physical objects from the second location of the facility.

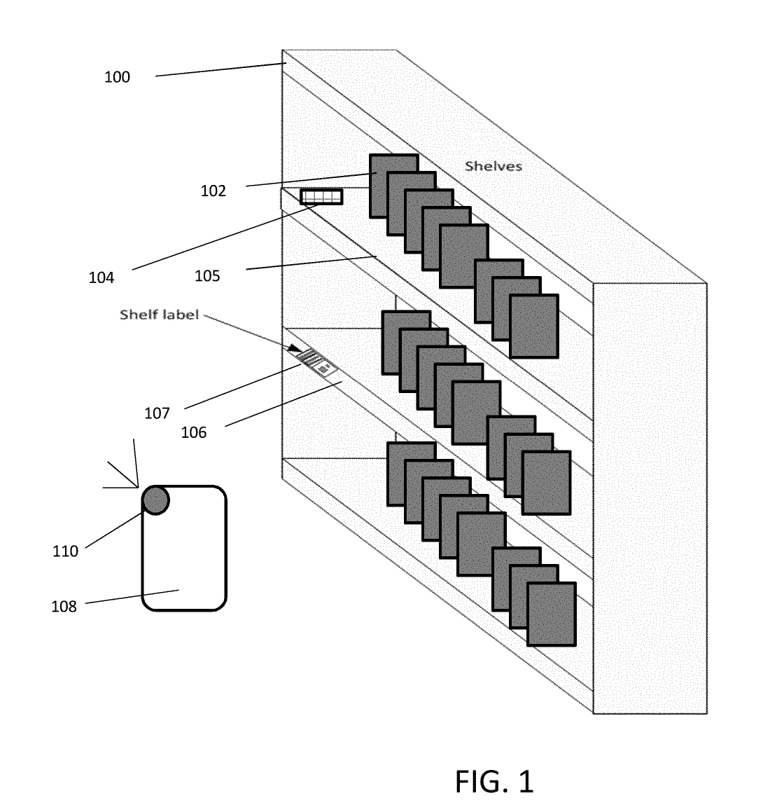

FIG. 1 is a block diagram of an exemplary shelving unit with electronic shelf-labels 107 according to an exemplary embodiment. The shelving unit 100 can include physical objects 102 disposed on shelves 105. The shelves 105 can be configured to support and store the physical objects 102. The shelves 105 can include a top or supporting surface extending the length of the shelf 10. Sensors 104 can be disposed on the supporting surface of the shelf 105 and can be configured to detect attributes associated with the physical objects 102. In one embodiment, the supporting structure that maintains the shelves 104 substantially parallel to horizontal can include vertical supports. The shelves 104 can also include a front face 106.

Electronic shelf-labels 107 can be disposed on the front face 106 of the shelves 105. The electronic shelf-labels 107 can include a display with light emitting diodes (LED). The electronic shelf-labels 107 can be configured to display information, via the LED display, that is associated with each of the like physical objects disposed on the shelves 104. Each electronic shelf-label 107 can be disposed underneath or with respect to the like physical object for which the electronic shelf label 107 is displaying information and to which the electronic shelf-label is assigned. The electronic shelf-label 107 can also display a machine-readable element encoded with an identifier associated with the set of like physical objects to which it is assigned.

The electronic shelf-label 107 can dynamically change the information rendered on the display based on signals received from a computing system. The electronic shelf-label 107 can communicate with the computing system.

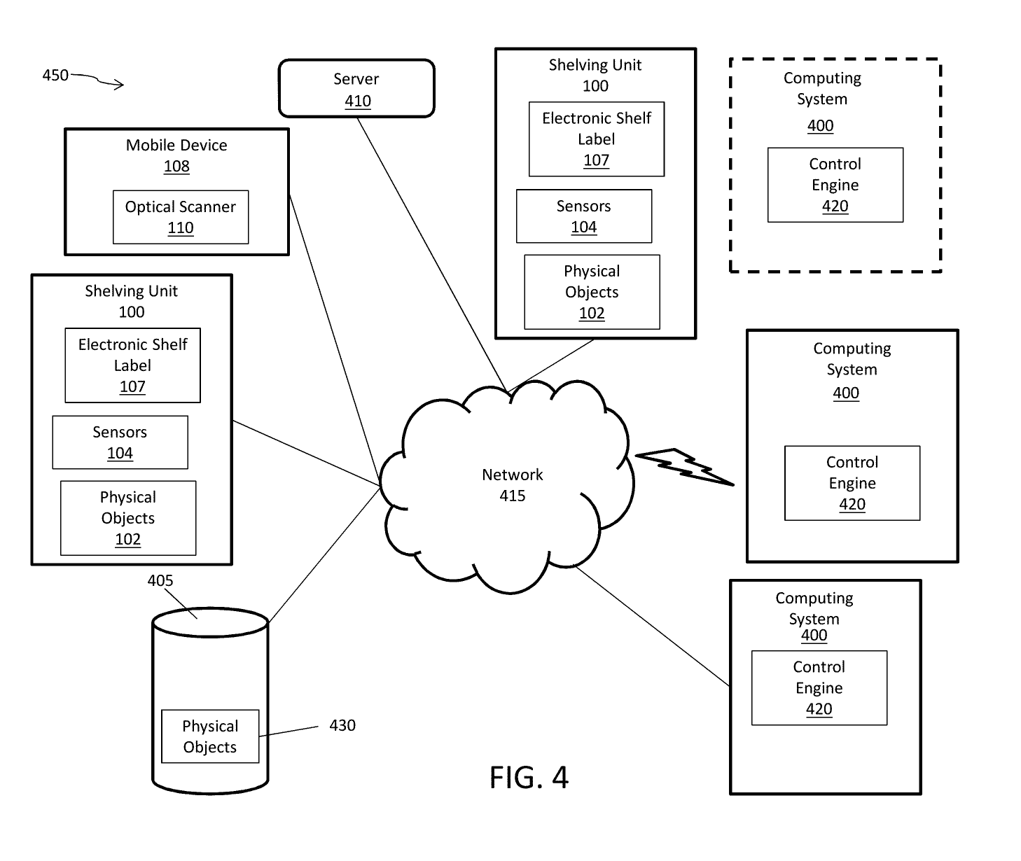

The sensors 104 can detect attributes associated with the physical objects disposed on the supporting surface of the shelf 105. The sensors can encode data indicative of the attributes into electrical signals signals and the sensors 104 can transmit the electrical signals to the computing system. Exemplary attributes can be, but are not limited to, quantity, weight, temperature, size, shape, color, object type, and moisture. The computing system will be discussed in further detail with respect to FIG. 4.

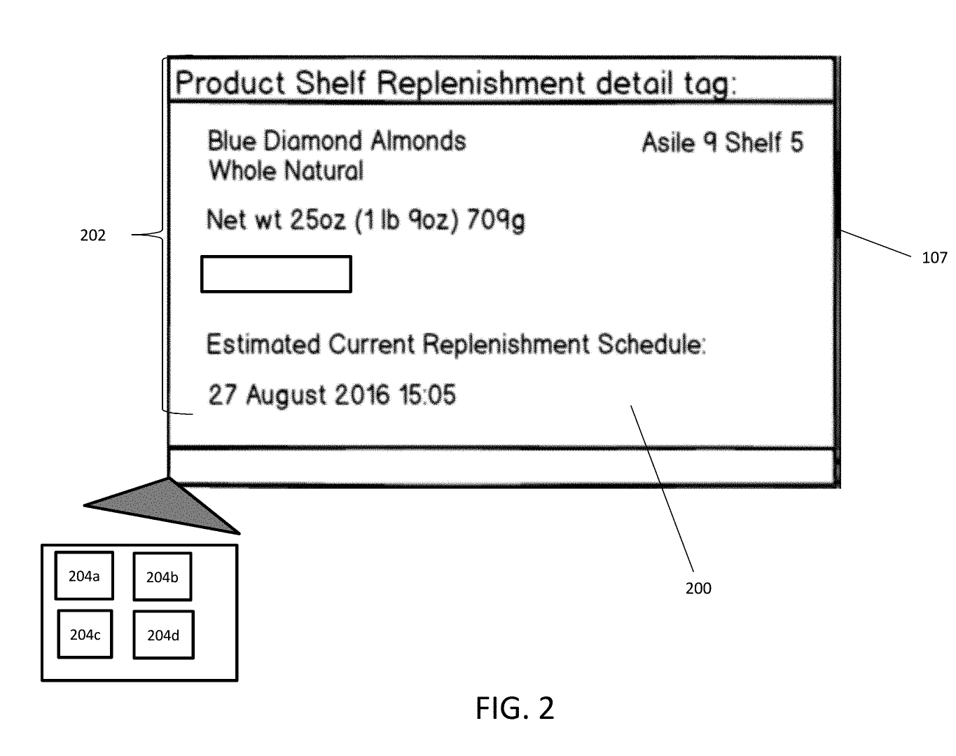

FIG. 2 is a block diagram of an exemplary electronic shelf-label 107 according to an exemplary embodiment. The electronic shelf-label 107 can include a LED display 200, a controller 204a, a power source 204b, a transceiver 204c, and memory 204d. The LED display 200 can be configured to be controlled by the controller 204a to display information 202 associated with a physical object. The information can include the name of the physical object, weight, size, dimensions, location within the facility, and a date and timestamp of when more like physical objects will be deposited in the location of the within the facility.

The power source 204b can provide power to the LED display 200, controller 204a, the transceiver 204c, and the memory 204d. The transceiver 204c can include a transmitter and a receiver and can be configured to communicate with the computing system. Based on signals received from the computing system, via the transceiver 204c, the controller 204a can control the display to change the information rendered on the LED display 200.

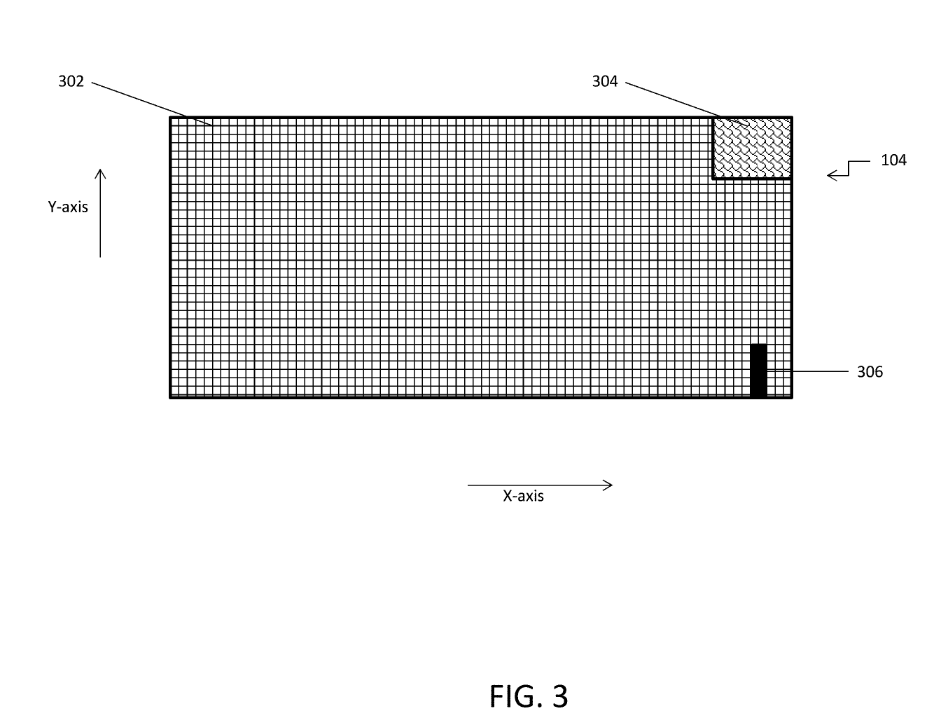

FIG. 3 illustrates an array of sensors 300 in accordance with an exemplary embodiment. The array of sensors 300 can be disposed at on the supporting surfaces of the shelves included on the shelving units. The array of sensors 300 may be arranged as multiple individual sensor strips 302 extending along the shelves, defining a sensing grid or matrix. Alternatively, or in addition, the array of sensors can be formed by individual sensor devices, such as pressure sensors, temperature sensors, moisture sensors, and the like. The array of sensors 300 can be built into the shelves itself or may be incorporated into a liner or mat disposed at the supporting surfaces of the shelves. Although the array of sensors 300 is shown as arranged to form a grid, the array of sensors can be disposed in other various ways. For example, the array of sensors 300 may also be in the form of lengthy rectangular sensor strips extending along either the x-axis or y-axis. The array of sensors 300 can detect attributes associated with the physical objects that are stored on the supporting surfaces of the shelves, such as, for example, detecting pressure or weight indicating the presence or absence of physical objects at each individual sensor 304. Alternatively, the sensors 300 may detect other attributes such as temperature or moisture associated with a physical object. In one embodiment, the supporting surface of the shelves is covered with an appropriate array of sensors 300 with sufficient discrimination and resolution so that, in combination, the sensors 304 are able to identify the quantity, and in some cases, the type of physical objects on the shelves.

In some embodiments, the array of sensors 300 may be formed of a piezoelectric material, which can measure various characteristics, including, for example, pressure, force, and temperature. While piezoelectric sensors are one suitable sensor type for implementing at least some of the sensor at the shelves, exemplary embodiments can implement other sensor types for determine attributes of physical objects including, for example, other types of pressure/weight sensors (load cells, strain gauges, etc.).

In some embodiments, the array of sensors 300 can be coupled to a radio frequency identification (RFID) device 306 with a memory having a predetermined number of bits equaling the number of sensors in the array of sensors 300 where each bit corresponds to a sensor 304 in the array of sensors 300. For example, the array of sensors 300 may be a 16×16 grid that defines a total of 256 individual sensors 304 and may be coupled to a 256 bit RFID device such that each individual sensor 304 corresponds to an individual bit. The RFID device including a 256 bit memory may be configured to store the location information of the shelving unit and in the facility and location information of merchandise physical objects on the shelves. Based on detected changes in pressure, weight, and/or temperature, the sensor 304 may configure the corresponding bit of the memory located in the RFID device (as a logic “1” or a logic “0”). The RFID device may then transmit the location of the shelves and data corresponding to changes in the memory to the computing system.

In some embodiments, the sensors can be operatively coupled to a controller and the controller can process the outputs of the sensors and transmit the one messages associated with the outputs of the sensors. The controller can store previously detected attributes from the sensors and can compare the current outputs of the sensors the previously detected attributes to determine whether any of the attributes changed since the previously detected attributes were output by the sensors. If there has been no change, the controller can wait a specified period of time before checking the output of the sensors again and no transmission may be sent to the computing system. If there has be a change to an attribute since the previously detected attributes were output from the sensors, the controller can transmit a message to the computing system identifying the change to the attribute(s) and can replace the previously detected attribute(s) with the current attributes in the memory.

It should be appreciated that in other embodiments, the sensors may be located in a position other than on the supporting surface of the shelf. For example, in one embodiment, the sensors may be embedded in the shelf. In another embodiment the sensors may be located immediately adjacent to the shelf. In one embodiment, the sensors may instead be located in the proximity of the shelf so that the shelf is within sensor range of the particular type of sensor. Further, in an embodiment, a mixture of sensor locations may be used.

FIG. 4 illustrates an exemplary electronic shelf-label system in accordance with exemplary embodiments of the present disclosure. The electronic shelf-label system 450 can include one or more databases 405, one or more servers 410, one or more computing systems 400, sensors 104, electronic shelf-labels 107, and mobile devices 108. The mobile devices 108 can include optical scanners 110 configured to scan machine-readable elements such as barcodes and/or QR codes. The sensors can be disposed on shelving units 100. Physical objects 102 can be disposed on the shelving units. The sensors 104 can be configured to detect attributes associated with physical objects 102 disposed on the shelving unit 100. The electronic shelf-labels 107 can also be disposed on the shelving units 100 and can be configured to display information associated with the physical objects 102 on a LED display. In exemplary embodiments, the computing system 400 is in communication with one or more of the databases 405, a server 410, the sensors 104, the electronic shelf-labels 107, and mobile devices 108 via a communications network 415. The computing system 400 can execute one or more instances of a control engine 420. The control engine 420 can be an executable application residing on the computing system 400. The control engine 420 can execute the process of the electronic shelf-label system 450 as described herein.

In an example embodiment, one or more portions of the communications network 415 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The computing system 400 includes one or more computers or processors configured to communicate with the databases 405, the sensors 104, electronic shelf-labels 107, and mobile devices 108 via the network 215. The computing system 400 hosts one or more applications configured to interact with one or more components of the electronic shelf-label system 450. The databases 405 may store information/data, as described herein. For example, the databases 405 can include a physical objects database 430. The physical objects database 430 can store information associated with physical objects. The databases 405 and server 410 can be located at one or more geographically distributed locations from each other or from the computing system 400. Alternatively, the databases 405 can be included within server 410 or computing system 400.

In one embodiment, the electronic shelf-label 107 can display information associated with like physical objects 102. For example, the information can include name of physical object, quantity of physical objects disposed on the shelving unit 100, type of physical object, size and dimensions of physical object, and a date and time additional physical objects will be deposited on the shelving unit 100. The electronic shelf-label 107 can also display a machine-readable element encoded with an identifier associated with the like physical objects. The sensors 104 can detect attributes associated with the like physical objects 102. The sensors 104 can detect weight, temperature, moisture, quantity, size and dimensions. The sensors 104 can encode the detected attributes into electrical signals and transmit the electrical signals to the computing system 400 (e.g., via a controller or RFID tag). In some embodiments, the sensors 104 can encode the detected attributes into electrical signals in response to detecting a change in attributes greater than a threshold amount.

The computing system 400 can execute the control engine 420 in response to receiving the electrical signals. The control engine 420 can decode the attributes from the electrical signals. The control engine 420 can query the physical objects database 430 to retrieve information associated with the physical objects. The information can include a particular electronic shelf-label assigned to the physical objects 102, a quantity of physical objects 102 disposed at the shelving unit 100 assigned to a particular electronic-shelf label, an average time the physical objects 102 assigned the particular shelf label remain disposed at the shelving unit 100 and a time required to add additional physical objects assigned to the particular electronic shelf-label to the shelving unit 100. The control engine 420 can determine the amount of time remaining before additional ones of the physical objects 102 assigned to the particular electronic shelf-label are disposed at the shelving unit 100 based on the quantity of physical objects 102 disposed at the shelving unit 100 and an average time the physical objects 102 remain disposed at the shelving unit 100. The control engine 400 can calculate a date and time additional physical objects will be deposited to the shelving unit 100. The control engine 420 can control the particular electronic shelf-label assigned to the physical objects to dynamically change the information rendered on the display to include the new determined date and time for the additional physical objects to be deposited to the shelving unit 100. The control engine 420 can transmit an alert in response to determining the quantity of physical objects disposed on the shelving unit is less than a predetermined threshold amount the control engine 420. In some embodiments, the alert is transmitted to the mobile device 108. In some embodiments, the control engine 420 can determine additional physical objects are disposed at a different location within the facility, and the control engine 420 can transmit a request to retrieve the physical objects from the different location within the facility and deposit the physical objects on the shelving unit 100. The control engine 420 can determine a new date and time for additional objects to be deposited on the shelving unit 100, and control the display of electronic shelf-label 107 to display the new date and time, as the physical objects 102 are removed from the shelving unit 100. When the additional physical objects are deposited on the shelf, the sensors can detect attributes associated with the additional objects and changes to the attributes can be sent to the computing system, which in turn can autonomous change the information rendered on the display (e.g., via the controller) of the particular electronic shelf-label. For example, the information rendered on the display can be change to remove the expected date and time additional physical objects are to be disposed on the shelf and/or to increase a quantity of physical objects on the shelf.

In some embodiments, the electronic shelf-label can display a machine readable element encoded with a identifier associated with the physical objects 102. The machine-readable element can be scanned and decoded using an optical scanner 110 of a mobile device 108. The mobile device 108 can transmit the decoded identifier to the computing system 400. The control engine 420 can query the physical objects database to retrieve information associated with the physical objects 102, using the identifier received from the mobile device 108. The control engine 420 can determine a date and time additional physical objects will be deposited on the shelving unit 100 as described above. The control engine 420 can change the display of the electronic shelf-label 107 from the machine readable element to the determined date and time additional physical objects will be deposited on the shelving unit 100.

As a non-limiting example, the electronic shelf-label system 250 can be implemented in a retail store. Products can be disposed on shelving units 100 in the retail store. Sensors 104 can be disposed on the shelving units 100. Electronic shelf-labels 107 can be disposed on the shelving units 100 and be configured to display information associated with the products. The information can include name of product, quantity of products disposed on the shelving unit 100, type of product, brand of product, size and dimensions of product, and a date and time additional products will be deposited on the shelving unit 100. The electronic shelf-label 107 can also display a machine-readable element encoded with an identifier associated with the like products. The sensors 104 can detect attributes associated with the like products. The sensors 104 can detect weight, temperature, moisture, quantity, size and dimensions. The sensors 104 can encode the detected attributes into electrical signals and transmit the electrical signals to the computing system 400. In some embodiments, the sensors 104 can encode the detected attributes into electrical signals in response to detecting a change in attributes greater than a threshold amount.

The computing system 400 can execute the control engine 420 in response to receiving the electrical signals. The control engine 420 can decode the attributes from the electrical signals. The control engine 420 can query the physical objects database 430 to retrieve information associated with the products. The information can include a quantity of products disposed at the shelving unit 100, an average rate of sale of the products and a time required to add additional products (e.g. restock the products) on the shelving unit 100. The control engine 420 can determine the amount of time remaining for the products to be disposed at the shelving unit 100 based on the products disposed at the shelving unit 100, an average rate of sale of the products. The control engine 400 can calculate a date and time additional products will be deposited to the shelving unit 100. The control engine 420 can control the electronic shelf-label to display the new determined date and time for the additional products to be deposited to the shelving unit 100. The control engine 420 in response to determining the quantity of products disposed on the shelving unit is less than a predetermined threshold amount the control engine 420 can transmit an alert. In some embodiments, the alert is transmitted to the mobile device 108. In some embodiments, the control engine 420 can determine additional products are disposed at a different location within the retail store (e.g. a stockroom). The control engine 420 can transmit a request to a mobile device of an store associate to retrieve the products from the different location within the retail store and deposit the products on the shelving unit 100. The control engine 420 can determine a new date and time for additional products to be deposited on the shelving unit 100, and control the display of electronic shelf-label 107 to display the new date and time, as the products are removed from the shelving unit 100.

In some embodiments, the electronic shelf-label can display a machine readable element encoded with a identifier associated with the products. The machine-readable element can be scanned and decoded using an optical scanner 110 of a mobile device 108. The mobile device 108 can transmit the decoded identifier to the computing system 400. The control engine 420 can query the products database to retrieve information associated with the products, using the identifier received from the mobile device 108. The control engine 420 can determine a date and time additional products will be deposited on the shelving unit 100 as described above. The control engine 420 can change the display of the electronic shelf-label 107 from the machine readable element to the determined date and time additional products will be deposited on the shelving unit 100.

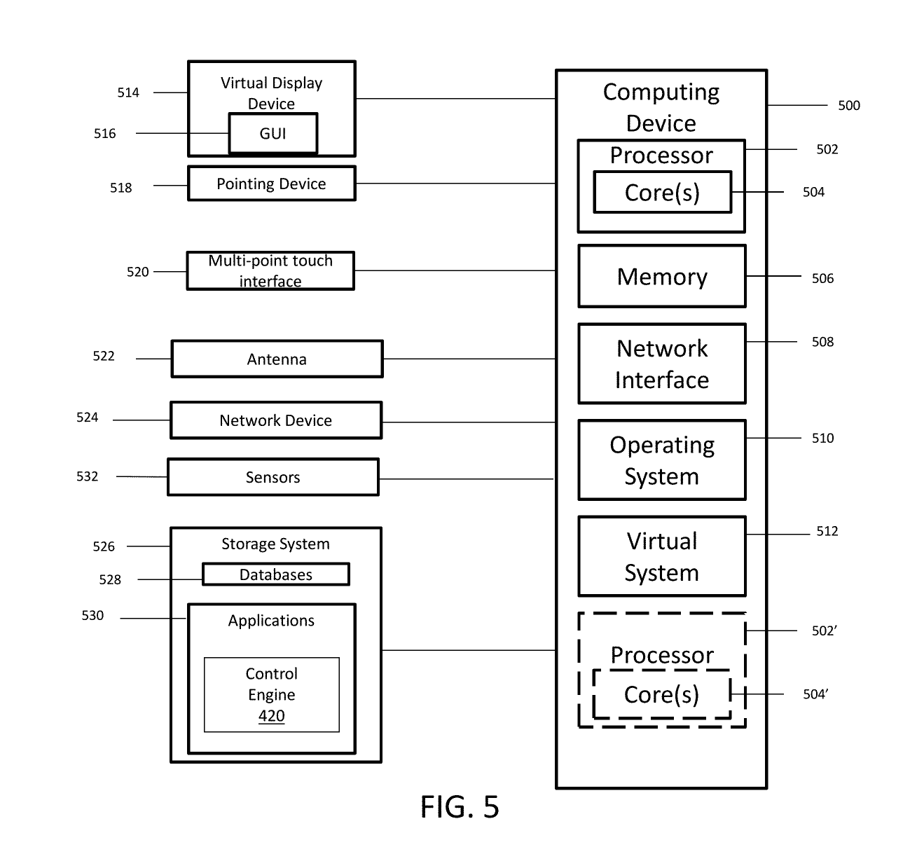

FIG. 5 is a block diagram of an exemplary computing device suitable for implementing embodiments of the automated shelf sensing system. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 506 included in the computing device 500 may store computer-readable and computer-executable instructions or software (e.g., applications 530) for implementing exemplary operations of the computing device 500. The computing device 500 also includes configurable and/or programmable processor 502 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for implementing exemplary embodiments of the present disclosure. Processor 502 and processor(s) 502′ may each be a single core processor or multiple core (504 and 504′) processor. Either or both of processor 502 and processor(s) 502′ may be configured to execute one or more of the instructions described in connection with computing device 500.

Virtualization may be employed in the computing device 500 so that infrastructure and resources in the computing device 500 may be shared dynamically. A virtual machine 512 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof. The computing device 500 can receive data from input/output devices such as, a reader 532.

A user may interact with the computing device 500 through a visual display device 514, such as a computer monitor, which may display one or more graphical user interfaces 516, multi touch interface 520 and a pointing device 518.

The computing device 500 may also include one or more storage devices 326, such as a hard-drive, CD-ROM, or other computer readable media, for storing data and computer-readable instructions and/or software that implement exemplary embodiments of the present disclosure (e.g., applications such as the control engine 420). For example, exemplary storage device 426 can include one or more databases 528 for storing information regarding the physical objects. The databases 528 may be updated manually or automatically at any suitable time to add, delete, and/or update one or more data items in the databases.

The computing device 500 can include a network interface 508 configured to interface via one or more network devices 524 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 522 to facilitate wireless communication (e.g., via the network interface) between the computing device 500 and a network and/or between the computing device 500 and other computing devices. The network interface 508 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

The computing device 500 may run any operating system 510, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 500 and performing the operations described herein. In exemplary embodiments, the operating system 510 may be run in native mode or emulated mode. In an exemplary embodiment, the operating system 510 may be run on one or more cloud machine instances.

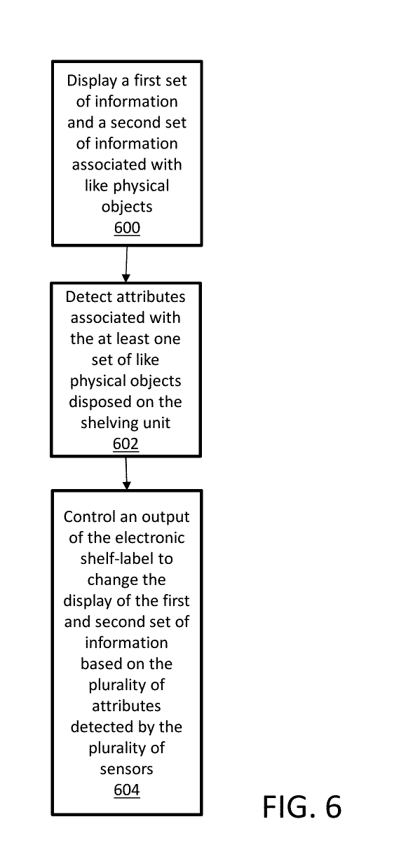

FIG. 6 is a flowchart illustrating an exemplary process performed by the electronic shelf system according to an exemplary embodiment. In operation 600, an electronic shelf-label (e.g. electronic shelf-label 107 as shown in FIGS. 1-2 and 3) disposed on shelving units (e.g. shelving units 100 as shown in FIGS. 1 and 4) and including an LED display (e.g. LED display 200 as shown in FIG. 2) can display a first set of information and a second set of information associated with like physical objects (e.g. physical objects 102 as shown in FIG. 1) disposed on the supporting surfaces of shelves (e.g. shelves 105 as seen in FIG. 1) of the shelving units. In operation 602, sensors (e.g. sensors 104 as shown in FIGS. 1, 3 and 4) disposed on the supporting surfaces of the shelves of the shelving unit, can detect attributes associated with the at least one set of like physical objects disposed on the shelving unit and assigned to the electronic shelf-label. The sensors can encode the attributes into electrical signals and transmit the electrical signals, directly or indirectly, to a computing system (e.g. computing system 400 as shown in FIG. 4). In operation 604, the computing system, can control an output of the at least one electronic shelf-label to change the display of the first and second set of information based on the attributes detected by the sensors.

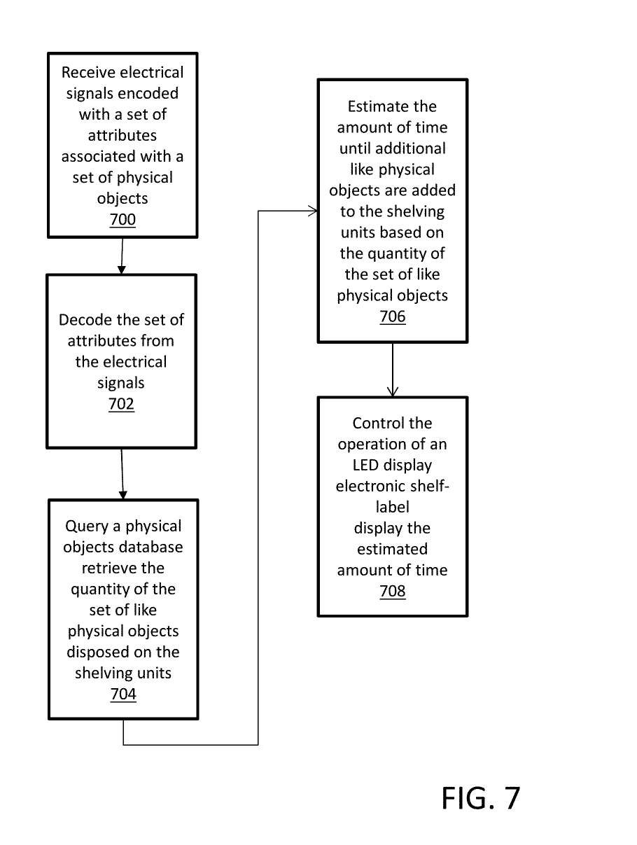

FIG. 7 is a flowchart illustrating an exemplary process performed by the electronic shelf system according to an exemplary embodiment. In operation 700, the computing system (e.g. computing system 400 as shown in FIG. 4) receives electrical signals encoded with a set of attributes associated with a set of physical objects (e.g. physical objects 102 as shown in FIG. 1) disposed on a supporting surface of a shelf (e.g. shelves 105 as shown in FIG. 1) of a shelving unit (e.g. shelving units 100 as shown in FIGS. 1 and 4), detected by sensors (e.g. sensors 104 as shown in FIGS. 1, 3 and 4) disposed the supporting surface of the shelf of the shelving unit. In operation 702, the computing system can decode the set of attributes from the electrical signals. In operation 704, the computing system can query a physical objects database (e.g. physical objects database 435 as shown in FIG. 4) to retrieve the quantity of the set of like physical objects disposed on the shelving units and assigned to the electronic shelf-label, based on the set of attributes output from the sensors. In operation 706, the computing system can estimate the amount of time until additional like physical objects assigned to the label are added to the shelving units based on the quantity of the set of like physical objects. In operation 708, the computing system can control the operation of an LED display (e.g. LED display 200 as shown in FIG. 2) of an electronic shelf-label (e.g. electronic shelf-label 107 as shown in FIGS. 1-2 and 3) associated with the set of physical objects to change the information rendered on the display to include, for example, the estimated amount of time.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An electronic shelf-label system, the system comprising:
a plurality of electronic shelf-labels disposed on shelving units, at least one of the plurality of electronic shelf-labels is configured to display a first set of information and a second set of information associated with at least one set of like physical objects disposed on the shelving units;
a plurality of sensors disposed on the shelving units, the plurality of sensors configured to detect a plurality of attributes associated with the at least one set of like physical objects disposed on the shelving unit; and
a computing system operatively coupled to the plurality of sensors and the plurality of electronic shelf-labels, the computing system configured to control an output of the at least one electronic shelf-label to change the display of the first and second set of information based on the plurality of attributes detected by the plurality of sensors.

2. The system in claim 1, wherein the set of attributes include one or more of weight, temperature and moisture.

3. The system in claim 1, wherein the first set of information is a quantity of the at least one set of like physical objects disposed on the shelving units and the second set of information is an amount of time until additional like physical objects are added to the shelving units.

4. The system in claim 3, further comprising a database coupled to the computing system.

5. The system in claim 4, wherein the computing system is configured to:
query the database to retrieve the quantity of at least one set of like physical objects disposed on the shelving units, based on the set of attributes;
estimate the amount of time until additional like physical objects are added to the shelving units based on the quantity of at least one set of like physical objects.

6. The system in claim 5, wherein the computing system is configured to transmit an alert in response to determining the amount of time is less than a specified threshold amount of time.

7. The system in claim 1, wherein the shelving units are disposed in a first location in a facility, and the computing system is configured to:
determine the at least one set of like physical objects are absent from the shelving units disposed in the first location in the facility;
determine additional like physical objects are present in a second location in the facility; and
transmit an alert to retrieve the additional like physical objects from the second location of the facility.

8. The system in claim 6, wherein the alert is transmitted to a mobile device.

9. The system in claim 1, wherein the at least one electronic shelf-label includes light emitting diodes.

10. An method comprising:
displaying, via at least one of a plurality of electronic shelf-labels disposed on shelving units, a first set of information and a second set of information associated with at least one set of like physical objects disposed on the shelving units;
detecting, via a plurality of sensors disposed on the shelving units, a plurality of attributes associated with the at least one set of like physical objects disposed on the shelving unit; and
controlling, via a computing system operatively coupled to the plurality of sensors and the plurality of electronic shelf-labels, an output of the at least one electronic shelf-label to change the display of the first and second set of information based on the plurality of attributes detected by the plurality of sensors.

11. The method in claim 10, wherein the set of attributes include one or more of weight, temperature and moisture.

12. The method in claim 10, wherein the first set of information is a quantity of the at least one set of like physical objects disposed on the shelving units and the second set of information is an amount of time until additional like physical objects are added to the shelving units.

13. The method in claim 12, wherein a database is coupled to the computing system, and the method further comprising:
querying, via the computing system, the database to retrieve the quantity of at least one set of like physical objects disposed on the shelving units, based on the set of attributes; and
estimating, via the computing system, the amount of time until additional like physical objects are added to the shelving units based on the quantity of at least one set of like physical objects.

14. The method in claim 13, further comprising transmitting, via the computing system, an alert in response to determining the amount of time is less than a specified threshold amount of time.

15. The method in claim 10, further comprising:
determining, via the computing system, the at least one set of like physical objects are absent from the shelving units disposed in a first location in the facility;
determining, via the computing system, additional like physical objects are present in a second location in the facility; and
transmitting, via the computing system, an alert to retrieve the additional like physical objects from the second location of the facility.

16. The method in claim 15, wherein the alert is transmitted to a mobile device.

17. The method in claim 10, wherein the at least one electronic shelf-label includes light emitting diodes.
